(19) United States
(12) Patent Application Publication
(10) Pub. No.: US 2015/0201193 A1
(43) Pub. Date: Jul. 16, 2015

(54) ENCODING AND DECODING TECHNIQUES FOR REMOTE SCREEN SHARING OF MEDIA CONTENT USING VIDEO SOURCE AND DISPLAY PARAMETERS

(71) Applicants: Qunshan Gu, Hayward, CA (US); Wei Jia, San Jose, CA (US)

(72) Inventors: Qunshan Gu, Hayward, CA (US); Wei Jia, San Jose, CA (US)

(73) Assignee: GOOGLE INC., Mountain View, CA (US)

(21) Appl. No.: 13/347,676

(22) Filed: Jan. 10, 2012

(51) Int. Cl. H04N 19/115; H04N 19/152; H04N 19/16; H04N 19/172; H04N 19/136; H04N 19/196

(52) U.S. Cl. CPC H04N 19/115; H04N 19/136; H04N 19/196; H04N 19/16; H04N 19/172; H04N 19/152

(57) ABSTRACT

Techniques for efficient coding of video content in relation to screen sharing are presented. A coder management component can detect native resolution and frame rate for video content from a video source and an original display resolution and frame rate associated with a local display window. The coder management component can identify the smaller resolution and smaller frame rate, and encode the video content using the smaller resolution and smaller frame rate for transmission to a remote device for display, e.g., in screen sharing. The coder management component can detect the display window size of the local display window and transmit the size to a remote device. At the remote device, a decoder can decode the video bitstream and reconstruct the video content in accordance with the smaller resolution, and can render and display the reconstructed video content in accordance with the display window size.

### TECHNICAL FIELD

This disclosure relates generally to processing of media content, and more specifically to encoding and decoding techniques for remote screen sharing of media content.

### BACKGROUND

The amount of data representing media information, such as a video image, can be extremely large. Further, transmitting digital video information over communication networks can consume large amounts of bandwidth. The cost of transmitting data from one location to another can be a function of number of bits transmitted per second. Typically, higher bit transfer rates can be associated with increased cost. Higher bit rates also can progressively add to required storage capacities of memory systems, which can thereby increase storage cost. Thus, at a given quality level, it can be significantly more cost effective to use a fewer number of bits, as opposed to a larger number of bits, to transmit and/or store digital video.

It therefore can be desirable to compress media data for recording, transmitting, or storing. For a typical compression scheme, achieving higher media quality can require using a relatively higher number of bits, which, in turn, can increase cost of transmission and storage. Moreover, while lower bandwidth traffic can be desired, higher quality media can be desired as well.

An encoder is a device capable of encoding (e.g., coding), and sometimes also decoding, digital media data. A decoder is a device capable of decoding digital media data. A codec is a device capable of coding and/or decoding digital media data. The term codec is derived from a combination of the terms code and decode, or the terms compress and decompress. A variety of codecs are commercially available. An encoder or codec, by encoding the digital media data, can reduce the number of bits required to transmit signals, which thereby can reduce associated transmission costs.

Often video can be encoded and decoded for use in video window sharing. Video window sharing can be a desirable part of a screen sharing application. A conventional technique for screen sharing such video windows is to simply code for the video screen from display/render buffers. When a video window is smaller, the conventional system will code the video content at a lower resolution, and when the video window is larger, the conventional system will code the video content at a higher resolution, without taking into account the video source. As a result, conventional video processing systems can be inefficient at both the local-video-window end and remote-video-window end.

### SUMMARY

The following presents a simplified summary of various aspects of this disclosure in order to provide a basic understanding of such aspects. This summary is not an extensive overview of all contemplated aspects, and is neither intended to identify key or critical elements nor delineate the scope of such aspects. Its purpose is to present some concepts of this disclosure in a simplified form as a prelude to the more detailed description that is presented later.

Systems and methods described in this disclosure relate to encoding of data (e.g., digital media data). This disclosure includes a system to facilitate screen sharing video content. The system comprises at least one memory that stores computer executable components. The system also can include at least one processor that executes the following computer executable components stored in the at least one memory: a coder component that encodes a video content associated with a video source to generate an encoded video bitstream for transmission to a remote device; and a coder management component that detects a subset of original display parameters associated with a local display window that displays the video content, detects a subset of video source parameters associated with the video source, and manages encoding of the video content based at least in part on the subset of original display parameters and the subset of video source parameters.

This disclosure also includes a method to facilitate screen sharing of video content. The method comprises employing at least one processor to facilitate execution of code instructions retained in at least one memory device. The at least one processor, in response to execution of the code instructions, perform acts comprising: detecting a subset of video source parameters associated with a video source that provides video content and a subset of original display parameters associated with a local display window that displays the video content; and controlling encoding of the video content, based at least in part on the subset of video source parameters and the subset of original display parameters, to generate an encoded video bitstream for transmission to a remote device.

Also disclosed in this specification is a system including means for identifying a subset of video source parameters associated with a video source that provides video content and a subset of original display parameters associated with a local display window that displays the video content. The system also includes means for managing encoding of the video content, based at least in part on the subset of video source parameters and the subset of original display parameters, to generate an encoded video bitstream, to facilitate screen sharing of the video content on a display associated with a remote device.

This disclosure also includes a method to facilitate screen sharing of video content on a remote device. The method comprises employing at least one processor to facilitate execution of code instructions retained in at least one memory device. The at least one processor, in response to execution of the code instructions, perform acts comprising: decoding an encoded video bitstream, comprising information associated with the video content, to facilitate reconstructing the video content, comprising a sequence of video images that are carried in the encoded video bitstream; identifying information relating to resolution and frame rate of the video images associated with the encoded video bitstream, wherein the resolution of the video images is smaller of a video source resolution and an original display resolution, and wherein the frame rate is smaller of a video source frame rate and an original display frame rate; identifying information relating to display window location and display window size associated with the encoded video bitstream; rendering reconstructed video content based at least in part on the resolution and the frame rate of the video images; and presenting the reconstructed video content on a display associated with the remote device in accordance with the display window size and the display window location.

The following description and the annexed drawings set forth in detail certain illustrative aspects of this disclosure. These aspects are indicative, however, of but a few of the various ways in which the principles of this disclosure may be employed. This disclosure is intended to include all such aspects and their equivalents. Other advantages and distinctive features of this disclosure will become apparent from the following detailed description of this disclosure when considered in conjunction with the drawings.

### BRIEF DESCRIPTION OF THE DRAWINGS

FIG. 1 illustrates a block diagram of an example system that can efficiently encode digital media data in accordance with various aspects and implementations described in this disclosure.

FIG. 2 depicts a block diagram of an example system that can encode and decode digital media data in accordance with various aspects and implementations of this disclosure.

FIG. 3 depicts a block diagram of an example encoder component in accordance with various aspects and implementations of this disclosure.

FIG. 4 illustrates a block diagram of an example decoder component in accordance with various aspects and implementations of this disclosure.

FIG. 5 depicts a flow diagram of an example method for encoding a video bitstream, in accordance with various aspects and implementations.

FIG. 6 presents a flow diagram of another example method for encoding a video bitstream, in accordance with various aspects and implementations.

FIG. 7 illustrates a flow diagram of an example method for decoding an encoded video bitstream, in accordance with various aspects and implementations.

FIG. 8 is a schematic block diagram illustrating a suitable operating environment.

FIG. 9 is a schematic block diagram of a sample-computing environment.

### DETAILED DESCRIPTION

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without these specific details, or with other methods, components, materials, etc. In other instances, well-known structures and devices are shown in block diagram form to facilitate describing one or more aspects.

Video encoding typically can be used to compress video, e.g., a sequence of video frames, for transmission and/or storage. In some applications, video can be encoded and decoded for use in video window sharing. Video window sharing can be a desirable part of a screen sharing application. A conventional technique for screen sharing such video windows is to simply code for the video screen from display/render buffers associated with the local viewing window. When a local video window is smaller, the conventional system will code the video content at a lower resolution, and when the local video window is larger, the conventional system will code the video content at a higher resolution, without taking into account the video source. This often can result in unnecessarily using a significant amount of bits. As a result, conventional video processing systems can be inefficient at both the local-video-window end and the remote-video-window end.

For example, an original video source may have video that has a low resolution. However, at the local video window, the video may be displayed in full-screen mode. Using the conventional technique for screen sharing, an encoder will code a high resolution video stream due to the video being displayed in full-screen mode on the local video window, even though the video from the video source is low resolution. This can result in the screen sharing being very slow and/or having relatively low quality due, for example, to processing cycle or bandwidth constraints due to the unnecessary coding of the video stream at a high resolution. In such instances, it can be desirable (e.g., more efficient) for the video to be coded for a low resolution to correspond with the low resolution of the original video source, instead of coding the video at the high resolution to correspond with the full-screen display of the video on the local video window. This is because coding the low resolution video for a higher resolution can be inefficient and can use an unnecessary amount of bandwidth and other resources, since the video source was low resolution and coding for a higher resolution will not be able to improve the quality of the original video from the source.

As another example, video content at the source may be generated at a relatively high resolution and conventionally would be coded at the high resolution, while, at the local video window, the video stream may be displayed in a smaller local video window, which can correspondingly have a lower resolution. In this instance, it can be desirable to code the video to correspond to the lower resolution associated with the smaller local video window, instead of coding the video based on the higher resolution of the source. This is because the video is likely to be displayed at the far end using a smaller remote video window that can correspond to the smaller local video window at the near end. As a result, coding of the video at the higher resolution for display on the remote video window can be inefficient because the smaller display size will not be able to provide the detail contained in a higher resolution video.

To that end, techniques for efficient coding of video content (e.g., in relation to video screen sharing) are presented. A coder management component can detect a resolution and frame rate for video content associated with a local display window before encoding, and can detect the resolution and frame rate associated with the video source (e.g., a local video file, streaming content, a video player, a capture device, etc.). The video content can include a sequence of video frames, for example. The coder management component can identify the smaller (or lower) of the resolution associated with the local display window and the resolution associated with the video source, and the smaller (or lower) of the frame rate associated with the local display window and the frame rate associated with the video source. The coder management component can control encoding of the video content to encode the video content using the identified smaller resolution and the identified smaller frame rate to generate an encoded video bitstream of the video. At the near end, the coder management component can scale the video frame in accordance with the desired (e.g., smaller) resolution.

The coder management component also can detect or identify the display window location and size being used to display the video on the local display window, wherein the size can be the display resolution, for example, for presentation of the video content on the local display window during a screen sharing session with a remote device. The coder management component can facilitate transmission of the display window location and size with the encoded video bitstream or in a separate data transmission to the remote device so that the decoder located at the remote device can have information to allow the decoder to know the display window size and location associated with the video content, so the remote display window can display the video content (e.g., reconstructed video content) to correspond with the display window size and location being used for the local display window at the near end.

At the far end (e.g., remote end), a decoder component can receive the encoded video bitstream (e.g., from the encoder component). The video images of the video content (e.g., the sequence of video frames) can be carried in the encoded video bitstream. The decoder component can decode the encoded video bitstream to reconstruct the video content (e.g., to reconstruct the video images carried in the encoded video bitstream). In some implementations, the decoder component can use a video or render buffer to store (e.g., temporarily store) the reconstructed video images and/or information relating to the reconstructed video images. The video buffer can facilitate reproducing the video content on a remote display window in accordance with desired (e.g., identified smaller) resolution and desired (e.g., identified smaller) frame rate. The decoder component also can obtain the information relating to the display window size and location associated with the encoded video bitstream. The decoder can facilitate rendering and displaying of the reconstructed video content to display the video content on the remote display window of the remote display component in accordance with the display window size and location as contained in the information relating to the display window size and location.

In accordance with various implementations, the coder management component can detect the original resolution and frame rate associated with a local display window (e.g., at the near end), depending in part on the video source. In some implementations, if the local display window is generated through bitstream decoding (e.g., through a network or when playing a local video file), the coder management component can detect the source (e.g., native) resolution from the bitstream and/or the near-end decoder component. In certain implementations, if the local display window is generated through a capture device (e.g., a camera or camcorder), a capture buffer associated with the capture device can represent or contain information corresponding to the original resolution of the video, and the buffer update rate can represent or correspond to the source (e.g., native) frame rate. The coder management component can identify the resolution of the video from the capture buffer and the frame rate from the buffer update rate. The coder management component also can detect the display/render resolution and frame rate from a render buffer.

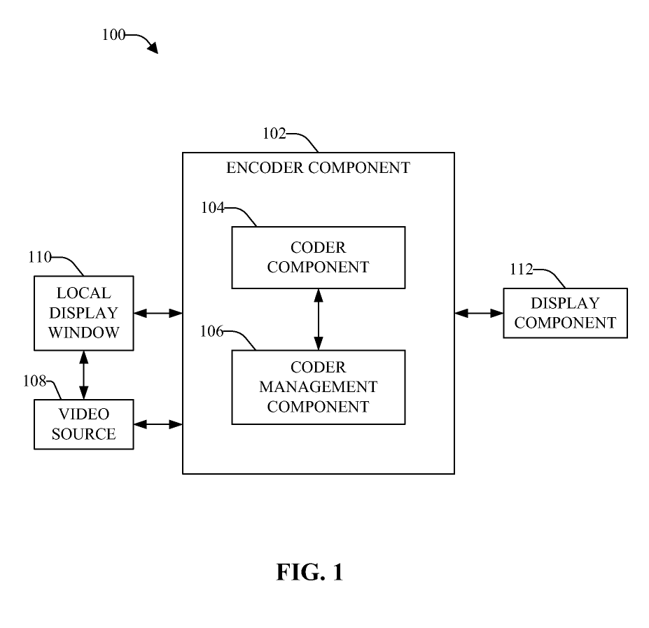

Referring now to the drawings, FIG. 1 illustrates a block diagram of an example system 100 that can efficiently encode digital media data in accordance with various aspects and implementations described in this disclosure. The system 100 can include an encoder component 102 that can encode digital media data (e.g., digital video content, audio content, still image, multimedia content, etc.) to produce encoded digital media data as an output, for example, as an encoded video bitstream. The encoder component 102 can encode or compress the digital media data in accordance with a defined encoding algorithm(s).

The encoder component 102 can include a coder component 104 that can encode the digital media data in accordance with the defined encoding algorithm(s). As part of the encoding process, the coder component 104 can compress the digital media data to facilitate reducing the amount of data to be transmitted or stored. Reducing the amount of data to be transmitted can facilitate transmitting data within bandwidth constraints, for example. Based at least in part on the encoding parameter settings, the coder component 104 can encode the digital media data to have a lower resolution or a relatively higher resolution and/or to have a lower frame rate or a relatively higher frame rate.

The encoder component 102 also can contain a coder management component 106 that can be associated with (e.g., communicatively connected to) the coder component 104. The coder management component 106 can dynamically and/or automatically control operations of the coder component 104 and/or other components to control encoding of digital media data in accordance with one or more defined encoding criterion. The defined encoding algorithm(s) can correspond, at least in part, to the one or more defined encoding criterion. The one or more defined encoding criterion can relate to, for example, the resolution of the video content from the video source 108, the resolution of the local display window 110 (e.g., before encoding), frame rate associated with the video source 108, frame rate associated with the local display window 110, window location and window size associated with the local display window 110 (e.g., when presenting the video content during a screen sharing session), type of video application, type of content, etc. The defined encoding criterion can be predefined, or can be identified, defined and/or implemented in real time by the coder management component 106.

In some implementations, the coder management component 106 can control operations of the coder component 104 relating to content intended to be displayed via video window sharing, for example, via use of a display-screen-sharing application. When coding digital media data (e.g., a video bitstream of video content, multimedia content, etc.), for example, in relation to video window sharing, the coder management component 106 can dynamically and/or automatically control encoding of digital media data based at least in part on detected parameters associated with the local display window 110 and the video source 108 (e.g., a local video file, streaming content, a video player, a capture device, etc.), in accordance with the one or more defined encoding criterion.

In accordance with various implementations, the coder management component 106 can detect an original resolution and original frame rate associated with a local display window 110 (e.g., at the near end) in relation to display of the content from the video source 108. The coder management component 106 can detect the original video source resolution and original frame rate for the digital media data associated with the local display window 110 (e.g. before encoding), based at least in part on the video source 108. For example, if the local display window 110 is generated through bitstream decoding (e.g., a local or near-end decoder (not shown) associated with the local display window 110), the coder management component 106 can detect the resolution (e.g., native resolution) associated with the video content (e.g., obtained from the video source 108) from the bitstream and/or the local decoder. As another example, a capture device can be the video source 108. If the local display window 110 is generated using the capture device (e.g., camera or camcorder), the coder management component 106 can detect the original resolution from a capture buffer (not shown), which can represent the original resolution for the video bitstream, and can detect the original frame rate from the buffer update rate, which can represent the frame rate (e.g., native frame rate), associated with the video content. In some implementations, the coder management component 106 can detect the display/render resolution and frame rate from a render buffer.

The coder management component 106 also can detect the display resolution and frame rate associated with the local display window 110 (e.g., at the near end as the content is being displayed on the local display window during a video screen sharing session). The coder management component 106 can identify the smaller (e.g., lower) of the resolution associated with the local display window 110 and the resolution (e.g., source or native resolution) of the video source 108. The coder management component 106 can identify the smaller (e.g., lower) of the frame rate associated with the local display window 110 and the frame rate associated with the video source 108. The coder management component 106 can control the coder component 104 to have the coder component 104 encode the content to generate an encoded video bitstream using the identified smaller resolution and the identified smaller frame rate.

In one embodiment, the coder management component 106 also can detect the display window location and window size associated with the local display window 110 in relation to displaying the content (e.g., as part of a video screen sharing session), wherein the size can be or correspond to the display resolution of the local display window 110 at the near end. The coder management component 106 can control transmission of information relating to the detected display window location and display window size to communicate such information with the encoded video bitstream or via a separate data transmission. For instance, the coder management component 106 can facilitate transmission of the encoded video bitstream and the information relating to the detected display window location and display window size (e.g., as a single integrated bitstream or as separate bitstreams) to a remote device via a same communication channel to facilitate desired display of the video content on a display component 112 at the far end. In some implementations, the coder management component 106 can facilitate transmission of the encoded video bitstream via a first communication channel and transmission of the information relating to the detected display window location and display window size to the remote device via a second communication channel.

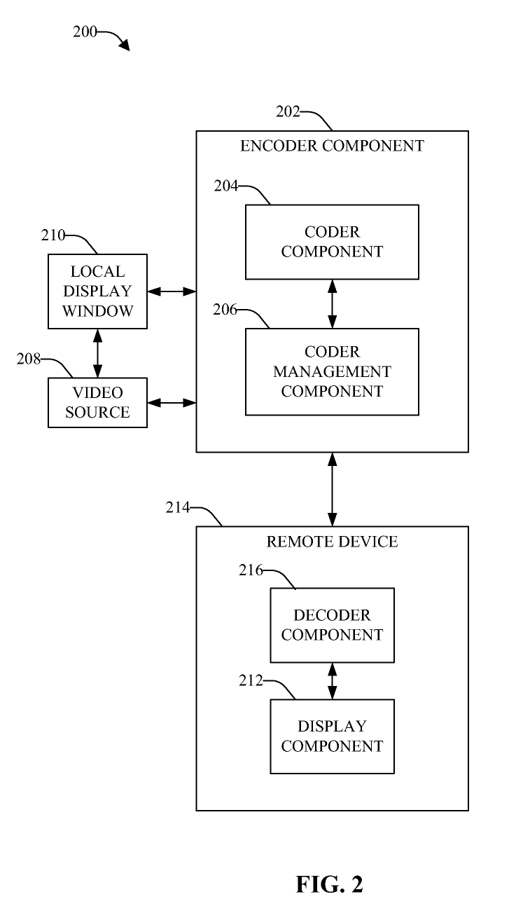

The remote end (e.g., remote device that can include a remote decoder component (not shown in FIG. 1; e.g., as depicted in FIG. 2) and display component (e.g., display component 112 in FIG. 1, display component 212 in FIG. 2)) can receive the information relating to the display window location and display window size. This received information can allow the remote end to know or obtain the display window size and location associated with the encoded video bitstream. As more fully disclosed in this disclosure (e.g., in relation to FIG. 2), the remote decoder component can decode the encoded video bitstream and/or other information, such as information relating to the display window location and/or display window size, to reconstruct the video content. Based at least in part on the encoding of the bitstream by the encoder component 102, the video content associated with the decoded bitstream can previously have been scaled by the coder management component 106 so the resolution and frame rate used for encoding the bitstream respectively can correspond to the identified smaller resolution and the identified smaller frame rate. The remote decoder component also can render the reconstructed video content to display the reconstructed video content on the display component 112 using the desired window size and in the desired window location on the display screen, in accordance with the received information relating to the display window location and/or display window size.

FIG. 2 depicts a block diagram of an example system 200 that can that can encode and decode digital media data in accordance with various aspects and implementations of this disclosure. The system 200 contains an encoder component 202 that can encode data (e.g., digital media data) associated with content (e.g., video content), as more fully disclosed in this disclosure. The encoder component 202 can include a coder component 204 that can encode the data associated with the content to generate an encoded video bitstream in accordance with the defined encoding algorithm(s). The encoder component 202 can contain a coder management component 206 that can be associated with (e.g., communicatively connected to) the coder component 204. The coder management component 206 can control encoding of the data (e.g., video content obtained from a video source 208) in accordance with one or more defined encoding criterion, which can be applied using the defined encoding algorithm(s), as more fully disclosed in this disclosure. For instance, the coder management component 206 can communicate control information and/or other information to the coder component 204 to facilitate controlling the encoding of digital media data by the coder component 204. For example, the coder management component 206 can communicate encoding parameters, resolution parameters, frame rate parameters, display window location parameters, and/or display window size parameters to the coder component 204 to facilitate controlling encoding of digital media data by the coder component 204.

The coder management component 206 can be associated with a local display window 210 via a communication connection (e.g., wireless or wireline communication channel), where the local display window 210 can be at a near end in relation to video sharing, and can display video content from a video source 208. When the encoder component 202 is preparing to encode data associated with video content provided in the local display window 210, the coder management component 206 can obtain, detect (e.g., sense), or identify the resolution and frame rate associated with the local display window 210.

The coder management component 206 also can obtain, detect, or identify the resolution and frame rate associated with the video content obtained from the video source 208. The coder management component 206 can analyze the display resolution and frame rate associated with the local display window 210, and the resolution and frame rate associated with the video content from the video source 208. Based at least in pant on the results of this analysis, the coder management component 206 can identify and select a desired resolution and desired frame rate to use when encoding the video content for use when screen sharing the content on a display component 212 on a remote device 214, in accordance with one or more defined encoding criterion, as more fully disclosed in this disclosure.

In some implementations, based at least in part on the results of the analysis, the coder management component 206 can identify the smaller of the resolution associated with local display window 210 and the resolution associated with the video source 208. The coder management component 206 also can identify the smaller of the frame rate associated with the local display window 210 and the frame rate associated with the video source 208. The coder management component 206 can control the coder component 204 to have the coder component 204 encode the digital media data to generate an encoded video bitstream using the identified smaller resolution and the identified smaller frame rate.

The coder management component 206 also can obtain, detect, or identify the display window location and display window size of the local display window 210. The coder management component 206 can communicate the information relating to the display window location and size with the encoded video bitstream to the remote device 214 (e.g., computer, cellular phone (e.g., smart phone), electronic pad, or other type of computing or communication device) that can include or be associated with the display component 212.

In some implementations, the remote device 214 can contain or be associated with a decoder component 216 that can receive the encoded video bitstream and the information relating to the display window location and size from the encoder component 202. The video images or frames of the video content can be carried in the encoded video bitstream. In some implementations, the encoder component 202 can scale the video images or frames of the video content (e.g., video frame sequence), based at least in part on the identified smaller resolution, prior to encoding the video content.

The decoder component 216 can decode the encoded video bitstream to reconstruct the video content (e.g., the video images or frames), in accordance with a defined decoding algorithm, which can correspond, at least in part, to the defined encoding algorithm used to encode the video bitstream. The decoder component 216 can store (e.g., temporarily store) the reconstructed video images and/or related information (e.g., information relating to the display window location and size to be used for displaying the video content) in a video or render buffer.

As part of the decoding process, the decoder component 216 can detect the display or render resolution (e.g., the identified smaller resolution) and frame rate (e.g., the identified smaller frame rate) from information contained in the encoded video bitstream. For instance, the decoder component 216 can detect the display or render resolution and frame rate from information contained in the video or render buffer, which can receive such data from the video bitstream. The decoder component 216 also can identify the display window location and size, which are display parameters to be used for display of the video content, from the received information relating to the display window location and size. The decoder component 216 can reconstruct the video information associated with the video images to correspond to the resolution-related information (e.g., information relating to the identified smaller resolution) contained in the video or render buffer. The decoder component 216 also can reconstruct the video information associated with the video images for render in a display window having a desired size in a desired display window location of the display component 212, in accordance with the information relating to the display window size and location.

The decoder component 216 can communicate (e.g., transmit) the reconstructed video content to the display component 212. The display component 212 can display the reconstructed video content, having the desired display size (e.g., corresponding to the desired display window size), in the desired display window location on the display screen of the display component 212.

In some implementations, the encoder component 202 can communicate the encoded video bitstream and/or the information relating to the display window location and size associated with the video content to facilitate storing such data in a data store or on computer-readable storage media. If the decoder component 216 has access to the data store or computer-readable storage media, the decoder component 216 can retrieve the encoded video bitstream and/or the information relating to the display window location and size associated with the video content from the data store or computer-readable storage media. The decoder component 216 can process (e.g., decode, analyze, etc.) the encoded video bitstream and/or the information relating to the display window location and size associated with the video content, as more fully disclosed in this disclosure.

By taking into account the respective resolutions and frame rates of the video source 208 and local display window 210), and selecting the resolution and frame rate that is more efficient in relation to the application (e.g., screen sharing application), implementations of this disclosure can more efficiently encode and decode digital media data, as compared to conventional systems and methods for encoding and decoding. Further, certain implementations of this disclosure also can improve transmission, display, and/or storage of video content, as compared to conventional systems and methods.

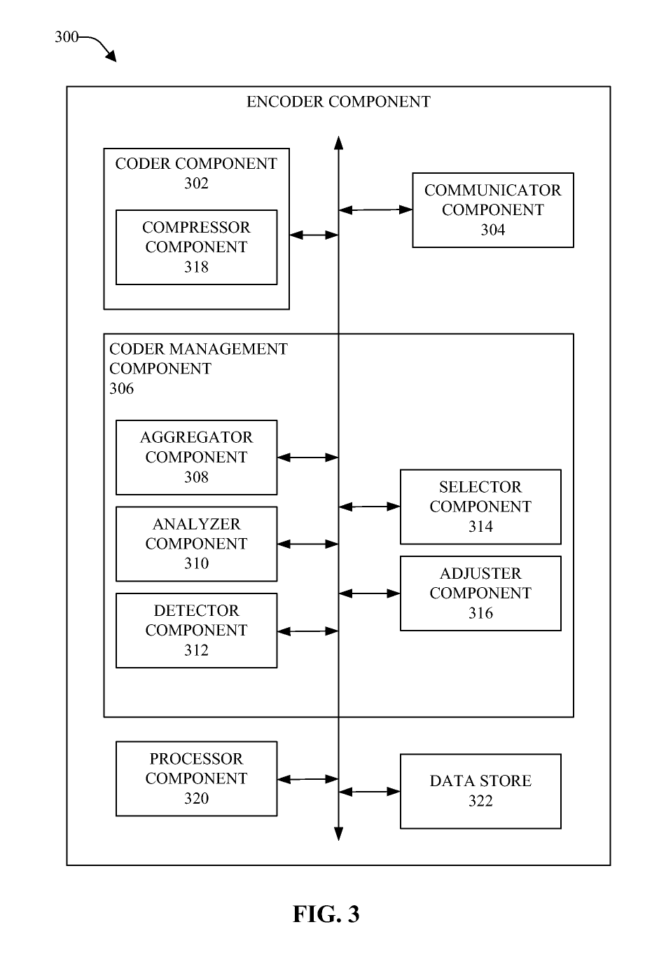

FIG. 3 illustrates a diagram of an example encoder component 300 in accordance with various aspects and implementations of this disclosure. The encoder component 300 can include a coder component 302 that can encode digital media data associated with video content to generate an encoded video bitstream in accordance with the defined encoding algorithm(s), as more fully disclosed in this disclosure.

The encoder component 300 can contain a communicator component 304 that can be used to communicate (e.g., transmit, receive) information, including digital media data associated with video content, an encoded video bitstream, information relating to the encoded video bitstream (e.g., information relating to display resolution, frame rate, display location, etc.), information that can facilitate encoding or decoding data associated with video content, etc. The communicator component 304 can communicate the information via one or more communication channels, which can include one or more wireless or wireline communication channel(s).

The encoder component 300 also can contain a coder management component 306 that can be associated with (e.g., communicatively connected to) the coder component 302 and communicator component 304. The coder management component 306 can control encoding of the data in accordance with one or more defined encoding criterion, which can be applied using the defined encoding algorithm(s).

The coder management component 306 can include an aggregator component 308, an analyzer component 310, a detector component 312, a selector component 314, and an adjuster component 316.

The aggregator component 308 can aggregate data received (e.g., obtained) from various entities (e.g., video source, remote device) or components (e.g., local display window, display component associated with the remote device, coder component 302, communicator component 304, processor 320, data store 322, etc.). The aggregator component 308 can correlate respective items of data based at least in part on type of data, source of the data, time or date the data was generated or received, encoding state of the data, a video frame to which the data relates, etc., to facilitate analysis of the data (e.g., by an analyzer component 310).

The analyzer component 310 that can analyze data relating to encoding data. In some implementations, the analyzer component 310 can analyze data relating to identifying and selecting a resolution and frame rate to use when encoding video content. The data can include, for example, respective video parameters associated with the video content, the video source, or the local display window at the near end. The video parameters can include, for example, resolution of the video content associated with the video source, frame rate of the video content associated with the source, display resolution associated with the local display window, frame rate associated with the local display window, display window location and/or size associated with the local display window, etc. The analyzer component 310 can generate analysis results, based at least in part on the data analysis, to facilitate enabling the coder management component 306 to efficiently manage encoding of the video content.

The detector component 312 can detect, sense, or otherwise obtain information relating to encoding video content. The information can include video parameters, information associated with the video parameters (e.g., metadata), video image or frame data, etc.

The selector component 314 can select items of information (e.g., video parameters, video image or frame data, metadata, a defined encoding algorithm or criterion, etc.) for use by the coder management component 306 or encoder component 300 to facilitate encoding of video content.

The adjuster component 316 can adjust or modify data associated with the video content to facilitate scaling of the video content when the video content is being encoded, based at least in part on the respective video parameters, in accordance with one or more defined encoding criterion. For example, the adjuster component 316 can modify digital video data during encoding of such data based at least in part the smaller of the resolution associated with the video source and the resolution associated with the local display window, and/or the smaller of the frame rate associated with the video source and the frame rate associated with the local display window.

In accordance with various implementations, the coder component 302 can include a compressor component 318 that can encode or compress data associated with video content in accordance with a defined compression or encoding algorithm. The compressor component 318 also can use a specified quantization value that can correspond to the compression level to be used during the encoding of the video content (e.g., raw video frame).

In some implementations, the encoder component 300 also can include a processor component 320 that can operate in conjunction with the other components (e.g., coder component 302, communicator component 304, coder management component 306, etc.) to facilitate performing the various functions of the encoder component 300. The processor component 320 can employ one or more processors, microprocessors, or controllers that can process data to facilitate performing operations, including encoding of video content, associated with the encoder component 300. The processor component 320 also can control data flow between the encoder component 300 and other components (e.g., video source, remote device, decoder component, display component, local display window, etc.) associated with the encoder component 300.

The encoder component 300 also can include a data store 322 that can store data structures (e.g., user data, metadata), instructions, procedures, and/or code structure(s) (e.g., modules, objects, hashes, classes) to facilitate performing or controlling operations associated with the encoder component 300. The data store 322 also can store information relating to encoding data or information relating to other operations of the encoder component 300 to facilitate encoding video content, or performing or controlling other operations, associated with the encoder component 300. In an aspect, the processor component 320 can be coupled (e.g., through a memory bus) to the data store 322 in order to store and retrieve information desired to operate and/or confer functionality, at least in part, to the components of the encoder component 300 (e.g., coder component 302, communicator component 304, coder management component 306, etc.), and/or substantially any other operational aspects of the encoder component 300.

The arrangement of the various components in the encoder component 300 is exemplary. In some implementations, the arrangement of components can be different than that shown for the encoder component 300. For example, in accordance with various implementations, one or more of the aggregator component 308, analyzer component 310, detector component 312, selector component 314, and/or adjuster component 316 can be structured as separate components from the coder management component 306. The coder management component 306 and/or other components (e.g., coder component 302) of the encoder component 300 can use or operate in conjunction with various components of the encoder component 300.

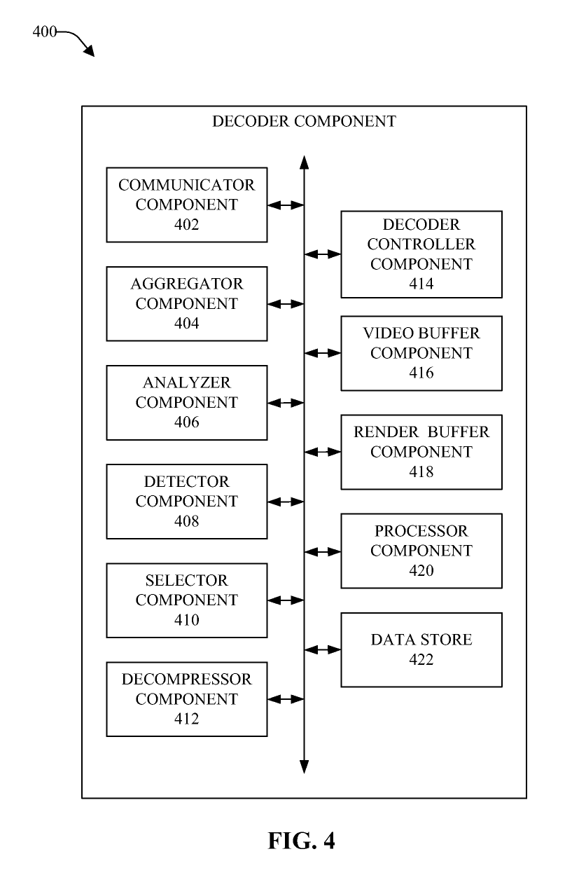

FIG. 4 depicts a block diagram of an example decoder component 400 in accordance with various aspects and implementations of this disclosure. The decoder component 400 can include a communicator component 402 that can be used to communicate (e.g., transmit, receive) information, including information relating to video content. The information can include, for example, an encoded video bitstream, information relating to the display window location and size associated with the video content, information relating to a display component or remote device associated with the decoder component 400, etc. The communicator component 402 can communicate information via one or more communication channels, which can include a wireless or wireline communication channel(s).

The decoder component 400 can contain an aggregator component 404, an analyzer component 406, a detector component 408, and a selector component 410.

The aggregator component 404 can aggregate data received (e.g., obtained) from various entities (e.g., processor, data store, encoder component, display component, remote device, etc.). The aggregator component 404 can correlate respective items of data based at least in part on type of data, source of the data, time or date the data was generated or received, encoding state of the data, a video frame to which the data relates, etc., to facilitate analyzing the data.

The analyzer component 406 can analyze data relating to decoding video content. The data can include, for example, information relating to video parameters associated with an encoded video bitstream, information relating to the display window location and size associated with the display component, or other information relating to the remote device), to generate analysis results. The decoder component 400 can use the analysis results to facilitate decoding the encoded video bitstream and reconstructing the video content for presentation (e.g., display) of the video content on the display component.

The detector component 408 can detect, sense, or otherwise obtain information relating to decoding an encoded video bitstream, or presenting decoded or reconstructed video content associated with the bitstream. The information can include media data (e.g., encoded digital media data), video parameters, information associated with the video parameters (e.g., metadata), etc.

The selector component 410 can select items of data (e.g., video parameters, video image or frame data, metadata, a defined decoding algorithm or criterion, etc.) for use by the decoder component 400 to facilitate decoding the encoded video bitstream, reconstruction of the video content from the bitstream, and/or presentation of the reconstructed video content.

In accordance with various implementations, the decoder component 400 can include a decompressor component 412. The decompressor component 412 can decode or decompress the encoded video bitstream associated with video content in accordance with a defined decompression or decoding algorithm. As part of the decoding process, the decompressor component 412 can reconstruct the video content from the decoded data associated with the bitstream to generate reconstructed video content for presentation on a display, such as the destination display component.

The decoder component 400 also can contain a decoder controller component 414 that can control decoding of encoded data, such as an encoded video bitstream. The decoder controller component 414 can operate in conjunction with the decompressor component 412 to decompress encoded data. In some implementations, the decoder controller component 414 can control decoding of an encoded video bitstream to facilitate reconstructing the video content (e.g., video images or frames) carried in the encoded video bitstream. The decoder controller component 414 can control reconstructing the video content associated with the bitstream to facilitate display of the video content in accordance with the desired resolution and desired frame rate, based at least in part on the information associated with the video images. The decoder controller component 414 also can render the video content for display of the content in the desired location and with the desired size on the display component, in accordance with the associated information relating to display window location and size, which can be received with the bitstream via a same communication channel or can be received via a separate communication channel.

The decoder component 400 can include a video buffer component 416 that can contain one or more video buffers that can be used to facilitate decoding the encoded video bitstream and reconstructing the video content. The video buffer component 416 can store information (e.g., reconstructed video content or other information relating thereto) in or retrieve information from the video buffer(s).

The decoder component 400 also can contain a render buffer component 418 that can include one or more render buffers that can store or provide information that can facilitate rendering decoded video content for presentation on a display (e.g., destination display component). For example, the render buffer component 418 can contain information relating to the display frame rate and/or the display or render resolution to use during decoding of the encoded video bitstream. The decoder controller component 414 can use this information to facilitate reconstructing the video images of the video content so the images can be presented on the destination display component to correspond with the display of the video images in the local display window at the near end.

In some implementations, the decoder component 400 also can include a processor component 420 that can operate in conjunction with the other components (e.g., communicator component 402, aggregator component 404, analyzer component 406, etc.) to facilitate performing the various functions of the decoder component 400. The processor component 420 can employ one or more processors, microprocessors, or controllers that can process data to facilitate performing operations, including decoding and/or reconstructing of video content, associated with the decoder component 400 The processor component 420 also can control data flow between the decoder component 400 and other components (e.g., encoder component, destination display component, etc.) associated with the decoder component 400.

The decoder component 400 also can include a data store 422 that can store data structures (e.g., user data, metadata), instructions, procedures, and/or code structure(s) (e.g., modules, objects, hashes, classes), to facilitate performing or controlling operations associated with the decoder component 400. The data store 422 also can store information relating to decoding data or information relating to other operations of the decoder component 400, to facilitate decoding or reconstructing video content, or performing or controlling operations, associated with the decoder component 400. In an aspect, the processor component 420 can be coupled (e.g., through a memory bus) to the data store 422 in order to store and retrieve information desired to operate and/or confer functionality, at least in part, to the components of the decoder component 400 (e.g., communicator component 302, aggregator component 404, analyzer component 406, etc.), and/or substantially any other operational aspects of the decoder component 400.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described in this disclosure for the sake of brevity, but known by those of skill in the art.

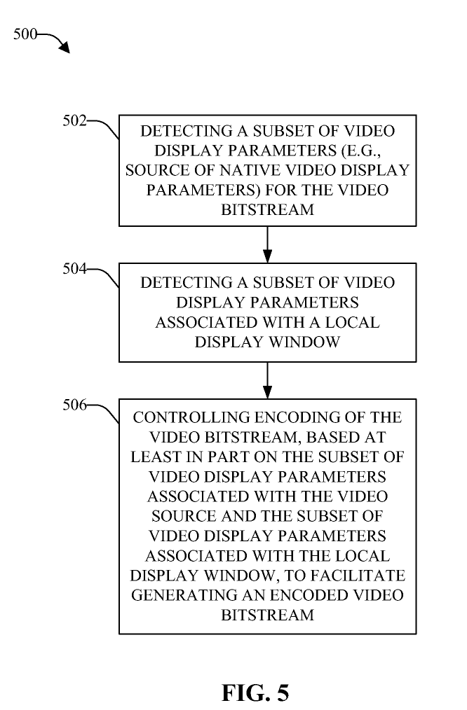

In view of the example systems, components, and devices described above, example methods that can be implemented in accordance with this disclosure can be further appreciated with reference to flowcharts in FIGS. 5-7. For purposes of simplicity of explanation, various methods disclosed in this disclosure are presented and described as a series of acts; however, it is to be understood and appreciated that this disclosure is not limited by the order of acts, as some acts may occur in different order and/or concurrently with other acts from that shown and described in this disclosure. It is noted that not all illustrated acts may be required to implement a described method in accordance with this disclosure. In addition, for example, one or more methods disclosed in this specification could alternatively be represented as a series of interrelated states or events, such as in a state diagram. Moreover, interaction diagram(s) or call flow(s) represent several of the example methods disclosed in this specification in accordance with the described subject matter; particularly in instances when disparate entities, or functional elements, enact disparate portions of one or more of the several methods. Furthermore, two or more of the disclosed example methods can be implemented in combination, to accomplish one or more features or advantages described in this disclosure.

With reference first to FIG. 5, illustrated is a flow diagram of an example method 500 for encoding a video bitstream, in accordance with various aspects and implementations. At 502, a subset of video display parameters (e.g., source of native video display parameters) for the video bitstream can be detected (e.g., using a coder management component). The subset of original video parameters can include, for example, the resolution and frame rate of the video content associated with a video source.

At 504, a subset of video display parameters associated with a local display window, which can display the video content at the near end, can be detected (e.g., using the coder management component). The subset of display video display parameters can include, for example, the display window resolution and display frame rate associated with the local display window at the near end.

At 506, encoding of the video bitstream can be controlled, based at least in part on the subset of video display parameters associated with the video source and the subset of video display parameters associated with the local display window, to facilitate generating an encoded video bitstream (e.g., using the coder management component). In some implementations, the coder management component can identify and select the smaller (e.g., lower) of the resolution associated with the video source and the resolution associated with the local display window. The coder management component also can identify and select the smaller of the frame rate associated with the video source and the display frame rate associated with the local display window. The coder management component can control encoding of the video bitstream, at least in part, by encoding the video bitstream using the identified smaller resolution and the identified smaller frame rate.

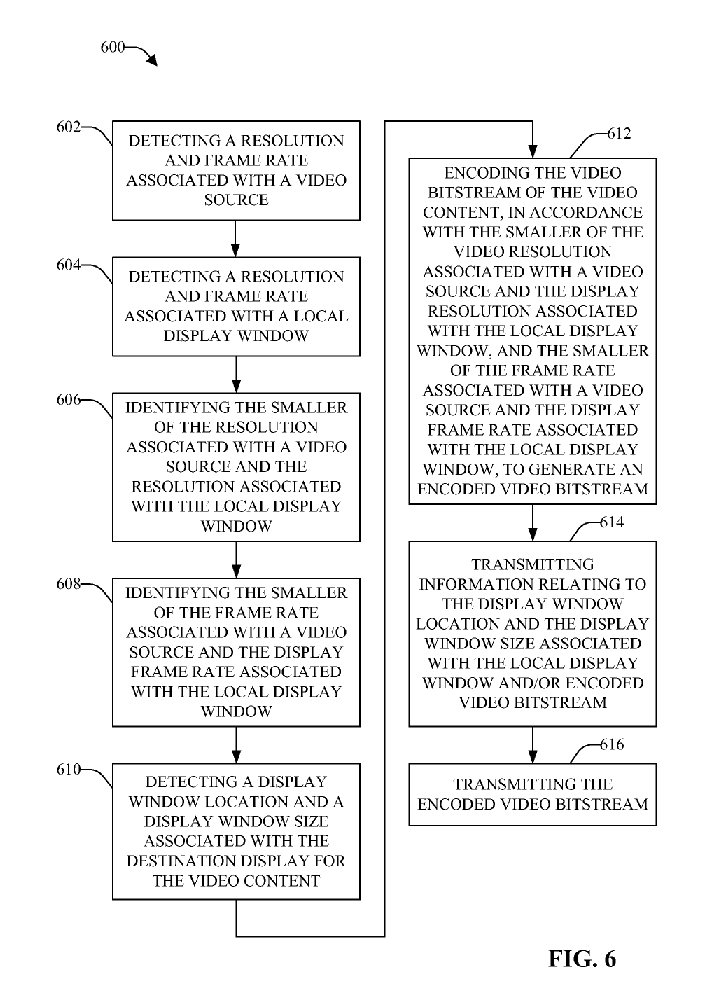

Referring next to FIG. 6, depicted is a flow diagram of another example a method 600 for encoding a video bitstream, in accordance with various aspects and implementations. At 602, a resolution and frame rate associated with a video source can be detected (e.g., using the coder management component). The resolution and frame rate can be associated with a video source in relation to presentation of video content, for example, by a local display window at a near end and a remote display window (e.g., as part of a display component) located at a far end when using an application for screen sharing. At 604, a display resolution and a display frame rate, which can be associated with the local display window for display of the video content at the near end, can be detected (e.g., using the coder management component).

At 606, the smaller of the resolution associated with a video source and the resolution associated with the local display window can be identified (e.g., by the coder management component). At 608, the smaller of the frame rate associated with a video source and the display frame rate associated with the local display window can be identified (e.g., using the coder management component).

At 610, a display window location and a display window size associated with the local display window can be detected (e.g., using the coder management component). At 612, the video bitstream of the video content can be encoded, in accordance with the smaller of the video resolution associated with a video source and the display resolution associated with the local display window, and the smaller of the frame rate associated with a video source and the display frame rate associated with the local display window, to generate an encoded video bitstream. The coder management component can control coding of the video bitstream, for example, by controlling the coder component to have the coder component encode the video bitstream to generate the encoded video bitstream, based at least in part on the one or more defined encoding criterion (e.g., in accordance with the defined encoding algorithm(s)).

At 614, information relating to the display window location and the display window size associated with the local display window and/or encoded video bitstream can be transmitted (e.g., using the encoder component) to the remote device associated with the remote display component. At 616, the encoded video bitstream can be transmitted (e.g., using the encoder component) to the remote device.

In some implementations, the encoder component can transmit the information relating to the display window location and the display window size, and the encoded video bitstream, via a same communication channel to the remote device. In some implementations, the encoder component can combine (e.g., integrate) the encoded video bitstream with the information relating to the display window location and size to generate a combined bitstream. The encoder component can transmit the combined bitstream to the remote device (e.g., the decoder component at the remote device). In yet other implementations, the encoder component can transmit the encoded video bitstream to the remote device via a first data communication using a communication channel, and can transmit the information relating to the display window location and size to the remote device via a second data communication using a second communication channel. In still other implementations, the encoder component can transmit the encoded video bitstream to the remote device via a first communication channel, and can transmit the information relating to the display window location and size via a second communication channel to the remote device.

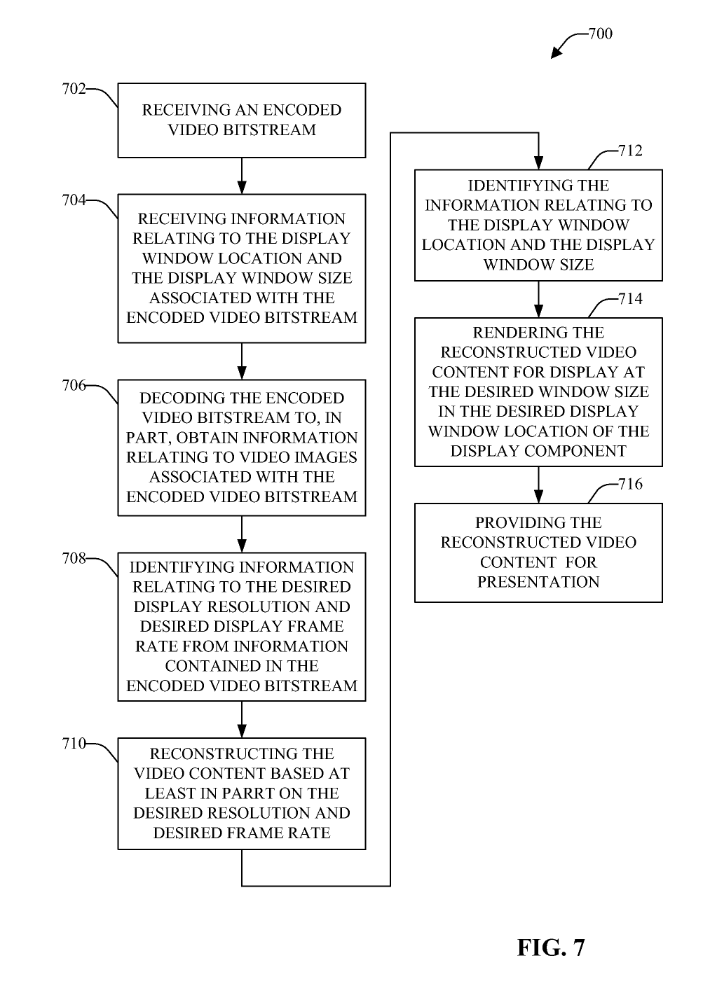

FIG. 7 presents a flow chart of an example method 700 for decoding an encoded video bitstream, in accordance with various aspects and implementations. At 702, an encoded video bitstream can be received (e.g., by a decoder component). The encoded video bitstream can be carrying video content that include a sequence of video images (e.g., video frames). At 704, information relating to the display window location and the display window size (e.g., display resolution), associated with the encoded video bitstream, can be received (e.g., by the decoder component). In some implementations, the decoder component can receive the information relating to the display window location and size with the encoded video bitstream via the same communication channel. In other implementations, the decoder component can receive the information relating to the display window location and size via a different communication channel than the communication channel used to receive the encoded video bitstream.

At 706, the encoded video bitstream can be decoded to, in part, obtain information relating to video images associated with the encoded video bitstream. The decoder component can decode the encoded video bitstream to reconstruct the video content associated with the video bitstream (e.g., generate reconstructed video content). When the decoder component decodes the video bitstream, the decoder component can identify and obtain information relating to the video images carried in the video bitstream. The information can include, for example, information relating to display resolution and frame rate associated with the video images. The decoder component can use this information to facilitate reconstructing the video images so that the video images can be displayed on the destination display component to correspond with the display of the video images in the local video window at the near end.

At 708, information relating to the desired display resolution and desired display frame rate can be identified from information contained in the encoded video bitstream. During decoding, the decoder component can identify the desired display resolution (e.g., identified smaller display resolution) and desired display frame rate (e.g., identified smaller frame rate), which can be contained in or associated with the encoded video bitstream. The desired resolution can be the resolution identified by the encoder component as being the smaller of the resolution associated with the video source and the resolution associated with the local display window at the near end. The desired frame rate can be the frame rate identified by the encoder component as being the smaller of the frame rate associated with the video source and the frame rate associated with the local display window at the near end.

At 710, the video content can be reconstructed based at least in part on the desired resolution and desired frame rate. The decoder component can reconstruct the video content to generate reconstructed video content based at least in part on the desired resolution and desired frame rate obtained from decoding the encoded video bitstream.

At 712, the information relating to the display window location and the display window size can be identified (e.g., using the decoder component). At 714, the reconstructed video content can be rendered for display at the desired window size in the desired display window location of the display component to facilitate presentation of the reconstructed video content in the desired display window location, with the desired window size, on the display component.

At 716, the reconstructed video content can be provided for presentation (e.g., display), e.g., in a display window of the display component. For example, the decoder component can provide (e.g., transmit) the reconstructed video content to the display component. The display component can present the reconstructed video content, which can have the identified resolution and frame rate (e.g., identified smaller resolution and smaller frame rate), in a display window having the identified size and location, which can correspond to how the video content is being displayed at the near end.

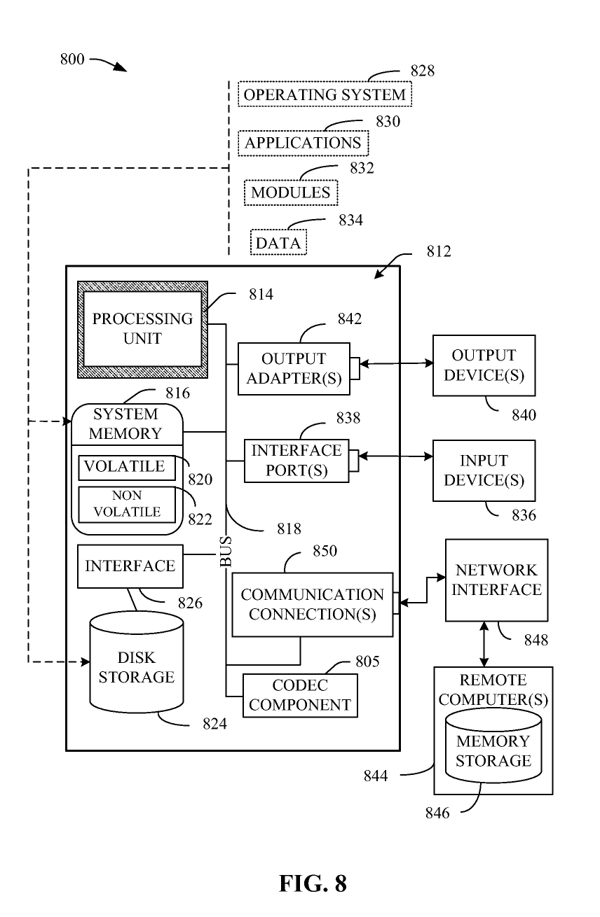

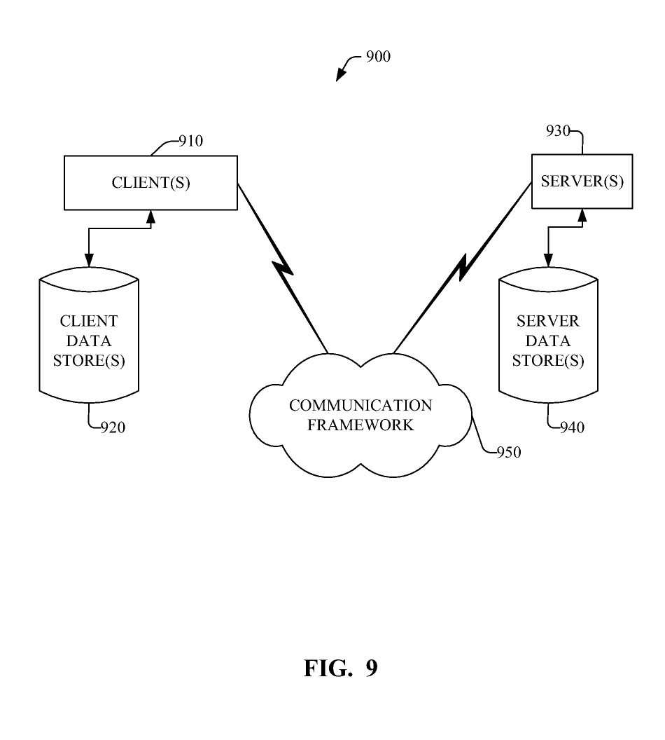

In order to provide a context for the various aspects of the disclosed subject matter, FIGS. 8 and 9 as well as the following discussion are intended to provide a brief, general description of a suitable environment in which the various aspects of the disclosed subject matter may be implemented. With reference to FIG. 8, a suitable environment 800 for implementing various aspects of this disclosure includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 820 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 812 also includes removable/non-removable, volatile/non-volatile computer storage media. FIG. 8 illustrates, for example, a disk storage 824. Disk storage 824 includes, but is not limited to, devices like a magnetic disk drive, floppy disk drive, tape drive, Jaz drive, Zip drive, LS-100 drive, flash memory card, or memory stick. The disk storage 824 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used, such as interface 826.

FIG. 8 also depicts software that acts as an intermediary between users and the basic computer resources described in the suitable operating environment 800. Such software includes, for example, an operating system 828. Operating system 828, which can be stored on disk storage 824, acts to control and allocate resources of the computer system 812. System applications 830 take advantage of the management of resources by operating system 828 through program modules 832 and program data 834, e.g., stored either in system memory 816 or on disk storage 824. It is to be appreciated that this disclosure can be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812, and to output information from computer 812 to an output device 840. Output adapter 842 is provided to illustrate that there are some output devices 840 like monitors, speakers, and printers, among other output devices 840, which require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

In accordance with various aspects and implementations, the computer (e.g., 812) can be used to perform desired computing or processing operations, including operations to encode or decode data, as more fully disclosed in this specification. In certain implementations, the computer 812 can include a codec component 805, which can include an encoder component and/or a decoder component, to encode and/or decode data, as more fully disclosed in this specification.

FIG. 9 is a schematic block diagram of a sample-computing environment 900 with which the subject matter of this disclosure can interact. The system 900 includes one or more client(s) 910. The client(s) 910 can be hardware and/or software (e.g., threads, processes, computing devices). The system 900 also includes one or more server(s) 930. Thus, system 900 can correspond to a two-tier client server model or a multi-tier model (e.g., client, middle tier server, data server), amongst other models. The server(s) 930 can also be hardware and/or software (e.g., threads, processes, computing devices). The servers 930 can house threads to perform transformations by employing this disclosure, for example. One possible communication between a client 910 and a server 930 may be in the form of a data packet transmitted between two or more computer processes.

The system 900 includes a communication framework 950 that can be employed to facilitate communications between the client(s) 910 and the server(s) 930. The client(s) 910 are operatively connected to one or more client data store(s) 920 that can be employed to store information local to the client(s) 910. Similarly, the server(s) 930 are operatively connected to one or more server data store(s) 940 that can be employed to store information local to the servers 930.

It is to be appreciated and understood that components (e.g., encoder component, coder component, coder management component, decoder component, etc.), as described with regard to a particular system or method, can include the same or similar functionality as respective components (e.g., respectively named components or similarly named components) as described with regard to other systems or methods disclosed in this specification.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described in this disclosure can be exploited in legacy telecommunication technologies, e.g., GSM. In addition, mobile as well non-mobile networks (e.g., the Internet, data service network such as internet protocol television (IPTV), etc.) can exploit aspects or features described in this disclosure.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed in this specification can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer-readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system. In another aspect, a component can be configured to perform one or more respective acts described in this disclosure. In another aspect, a component performs one or more respective acts described in this disclosure.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used in this disclosure, the terms “example” and/or “exemplary” are utilized to mean serving as an example, instance, or illustration. For the avoidance of doubt, the subject matter disclosed in this specification is not limited by such examples. In addition, any aspect or design described in this disclosure as an “example” and/or “exemplary” is not necessarily to be construed as preferred or advantageous over other aspects or designs, nor is it meant to preclude equivalent exemplary structures and techniques known to those of ordinary skill in the art.

Various aspects or features described in this disclosure can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described in this disclosure, including a disclosed method(s). The term “article of manufacture” as used in this disclosure can encompass a computer program accessible from any computer-readable device, carrier, or storage media. For example, computer-readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described in this disclosure. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described in this disclosure can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods in this disclosure are intended to include, without being limited to including, these and any other suitable types of memory.

It is to be appreciated and understood that components (e.g., encoder component, codec, estimator component, coder component, resource controller component, etc.), as described with regard to a particular system or method, can include the same or similar functionality as respective components (e.g., respectively named components or similarly named components) as described with regard to other systems or methods disclosed in this specification.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. A system to facilitate screen sharing video content, the system comprising:
at least one memory that stores computer executable components; and
at least one processor that executes the following computer executable components stored in the at least one memory:
a coder component configured to:
receive captured video content associated with a video source, and
encode the captured video content to generate an encoded video bitstream for transmission to a remote device; and
a coder management component configured to:
receive a plurality of parameters associated with a display of the remote device,
determine a video display resolution, from the plurality of parameters, associated with a display window that displays the video content on the display of the remote device,
determine a video source resolution associated with the video source from a plurality of video source parameters,
control scaling of the captured video content using the smaller of the video source resolution and the video display resolution, and
control encoding of the scaled captured video content by the coder.

2. The system of claim 1, wherein the plurality of parameters associated with the display of the remote device includes at least one of the video display resolution or video display frame rate.

3. The system of claim 1, wherein the plurality of video source parameters includes at least one of the video source resolution or a video source frame rate.

4-5. (canceled)

6. The system of claim 1, wherein the coder management component is further configured to:
determine a video display frame rate, from the plurality of parameters, associated with the display window that displays the video content on the display of the remote device;
determine a video source frame rate associated with the video source from the plurality of video source parameters; and
encode the video bitstream based on the smaller of the video display frame rate and the video source frame rate.

7. The system of claim 1, wherein, when the display window that displays the video content on the display of the remote device is generated through decoding, by a decoder component associated with a video bitstream from the video source, the coder management component detects the video source resolution associated with the video source from one of the video bitstream or the decoder component.

8. The system of claim 1, wherein
the coder management component detects the video source resolution, based on a capture buffer when the local display window is generated by a capture device, wherein the capture buffer is indicative of the video source resolution; and
the coder management component detects the video source frame rate based on a buffer update rate associated with the capture buffer.

9. The system of claim 1, wherein the coder management component detects a display window size associated with the local display window, and transmits information relating to the display window size before or simultaneously with transmission of the encoded video bitstream.

10. The system of claim 9, wherein the coder management component detects a display window location associated with the local display window, and transmits information relating to the display window location before or simultaneously with transmission of the encoded video bitstream.

11. The system of claim 9, wherein the coder management component transmits the information relating to the display window size via a first communication channel that is also being used to transmit the encoded video bitstream.

12. The system of claim 9, wherein the coder management component combines the information relating to the display window size with the encoded video bitstream to generate a single encoded video bitstream, and transmit the single encoded video bitstream to the remote device associated with the display component.

13. The system of claim 9, wherein the coder management component transmits the encoded video bitstream via a first communication channel and transmits the information relating to the display window size via a second communication channel.

14. A method to facilitate screen sharing of video content, the method comprising:
employing at least one processor to facilitate execution of code instructions retained in at least one memory device, the at least one processor, in response to execution of the code instructions, perform acts comprising:
receive captured video content associated with a video source;
determine a video source resolution associated with a video source that provides the captured video content;
determine a video display resolution associated with a display window that displays the video content on a display of a remote device;
scale the captured video content using the smaller of the video source resolution and the video display resolution; and
control encoding of the scaled captured video content to generate an encoded video bitstream for transmission to the remote device.

15. The method of claim 14, further comprising:
determining a video source frame rate associated with the video source; and
determining display frame rate associated with the display window.

16. The method of claim 15, further comprising:
encoding the video content based on the smaller of the video source frame rate and the display frame rate.

17. The method of claim 16, further comprising:
detecting a display window size associated with the display window in relation to displaying the video content; and
transmitting information relating to the display window size before or concurrently with transmission of the encoded video bitstream.

18. The method of claim 17, further comprising:
detecting a display window location associated with the display window in relation to displaying the video content; and
transmitting information relating to the display window location before or concurrently with transmission of the encoded video bitstream.

19. The method of claim 18, further comprising:
transmitting the information relating to the display window location and the display window size via a first communication channel being used to transmit the encoded video bitstream.

20. The method of claim 18, further comprising:
transmitting the encoded video bitstream via a first communication channel; and
transmitting the information relating to the display window location and the display window size via a second communication channel.

21. A system, comprising:
means for receiving captured video content associated with a video source;
means for determining a video source resolution associated with a video source that provides video content; and
means for determining a video display resolution associated with a display window that displays the video content on a display of a remote device;
means for scaling the captured video content using the smaller of the video source resolution and the video display resolution; and
means for managing encoding of the scaled captured video content to generate an encoded video bitstream to facilitate screen sharing of the video content on a display associated with the remote device.

22. A method to facilitate screen sharing of video content on a remote device, the method comprising:
employing at least one processor to facilitate execution of code instructions retained in at least one memory device, the at least one processor, in response to execution of the code instructions, perform acts comprising:
decoding an encoded video bitstream, including information associated with the video content, to facilitate reconstructing the video content, including a sequence of video images that are carried in the encoded video bitstream;
identifying information relating to resolution and frame rate of the video images associated with the encoded video bitstream, wherein the resolution of the video images is the smaller of a video source resolution and a video display resolution, and wherein the frame rate is the smaller of a video source frame rate and a video display frame rate associated with a display window that displays the video content on a display of the remote device;
identifying information relating to display window location and display window size associated with the encoded video bitstream;
rendering reconstructed video content based on the resolution and the frame rate of the video images; and
presenting the reconstructed video content on a display associated with the remote device in accordance with the display window size and the display window location.
